(19) United States
(12) Patent Application Publication
(10) Pub. No.: US 2017/0118320 A1
(43) Pub. Date: Apr. 27, 2017

(54) ILLUMINABLE MOBILE TERMINAL

(71) Applicants: LE HOLDINGS (BEIJING) CO., LTD., Beijing (CN); Lemobile Information Technology (Beijing) Co., Ltd, Beijing (CN)

(72) Inventor: Decai ZHU, Beijing (CN)

(21) Appl. No.: 15/247,787

(22) Filed: Aug. 25, 2016

Related U.S. Application Data
(63) Continuation of application No. PCT/CN2016/087025, filed on Jun. 24, 2016.

(30) Foreign Application Priority Data
Oct. 22, 2015 (CN) 201520826099.0

(51) Int. Cl. H04M 1/22; H04M 1/02

(52) U.S. Cl. CPC H04M 1/22; H04M 1/0266

(57) ABSTRACT

Disclosed is a illuminable mobile terminal, which includes an azimuth acquiring unit, an information processing unit, a servo unit and a lighting unit, wherein the azimuth acquiring unit is used for acquiring azimuth information data of a user in real time; the information processing unit is used for extracting direction information data in the azimuth information data acquired by the azimuth acquiring unit and used for transmitting the direction information data to the servo unit; the servo unit is used for adjusting the angle of the lighting unit according to the direction information data; the lighting unit is used for projecting a light pillar to the ground or the surface of a building. The present disclosure aims to provide light to the user and help the user to distinguish directions under the condition that the user is in poor view and dim light and moreover a GPS is “lost”.

### CROSS-REFERENCE TO RELATED APPLICATIONS

The present disclosure is a continuation of International Application No. PCT/CN016/087025, filed on Jun. 24, 2016; which is based upon and claims priority to Chinese Patent Application No. 201520826099.0, entitled “ILLUMINABLE MOBILE TERMINAL”, filed on Oct. 22, 2015, the entire contents of all of which are incorporated herein by reference.

### TECHNICAL FIELD

The present disclosure generally relates to the field of electronics, and in particular to an illuminable mobile terminal.

### BACKGROUND

Along with popularization of outdoor recreation at present, more and more people like outdoor adventures, and more and more various professional outdoor products such as a professional navigator GPS devices and a professional outdoor flashlights are available. However, the professional outdoor facilities may also be “lost” sometimes, for example, when an outdoor amateur passes through an extreme zone or encounters extreme weather, if the signal of the GPS is poor or interrupted at dark night, the outdoor amateur may get lost at an awkward moment.

In addition, people particularly hope that unfamiliar roads may be clear and directions may be distinguished at night or in weather with dim light. Due to application of a compass in a mobile terminal, the direction may be shown and checked by a user, but a flashlight cannot be powered on for lighting when the compass is used to show the direction at the same time.

To sum up, under conditions of poor light or view, how to provide a portable mobile terminal which may both provide light to people and help people to distinguish directions so that “the direction is not lost even when a satellite is lost” when the GPS is “lost” becomes a problem needing to be solved urgently.

### SUMMARY

The embodiment of the present disclosure discloses an illuminable mobile terminal, and aims to provide light to a user and help the user to distinguish directions under the condition that the view is poor or light is dim and a GPS is “lost”.

To solve the problem above, the present disclosure discloses an illuminable mobile terminal.

The illuminable mobile terminal disclosed by the embodiment of the present disclosure includes an azimuth acquiring unit, an information processing unit, a servo unit and a lighting unit, Wherein:
the azimuth acquiring unit is used for acquiring azimuth information data of a user in real time;
the information processing unit is used for extracting direction information data in the azimuth information data acquired by the azimuth acquiring unit and transmitting the direction information data to the servo unit;
the servo unit is used for adjusting the angle of the lighting unit according to the direction information data;
the lighting unit is used for projecting a light pillar to the ground or the surface of a building.

According to the illuminable mobile terminal disclosed by the embodiment of the present disclosure, the azimuth acquiring unit is an electronic compass or as 3D electronic compass.

According to the illuminable mobile terminal disclosed by the embodiment of the present disclosure, the information processing unit is a CPU.

According to the illuminable mobile terminal disclosed by the embodiment of the present disclosure, the servo unit is a driving motor.

According to the illuminable mobile terminal disclosed by the embodiment of the present disclosure, the lighting unit further includes a lens with a marking arrow and is used for projecting a light beam to the ground or the surface of a building through the lens with the marking arrow.

According to the illuminable mobile terminal disclosed by the embodiment of the present disclosure, the mobile terminal is a mobile phone or a tablet personal computer.

According to the illuminable mobile terminal disclosed by the embodiment of the present disclosure, direction information may be acquired from the azimuth acquiring unit through the information processing unit and is transmitted to the servo unit, and the angle of the lens in the lighting unit may be adjusted through the servo unit, so that the light beam may be projected to the ground or the surface of the building through the lens with the marking arrow, and the effect that both light and direction information are provided to the user at the same time under the conditions that the view is poor or the light is dim and the GPS is “lost” may be achieved.

### BRIEF DESCRIPTION OF FIGURES

To clearly describe the technical schemes in the embodiments of the present disclosure or in the prior art, figures needing to be used in the description of the embodiments or the prior art are briefly introduced in the followings, obviously, the figures in the following description are some embodiments of the present disclosure, and for common technicians of the field, other figures may be obtained according to the figures under the condition that no creative work is made.

FIG. 1 shows the structure block diagram of the illuminable mobile terminal disclosed by the embodiment of the present disclosure.

FIG. 2 shows the block diagram of a computing device in the embodiment of the present disclosure.

FIG. 3 shows a storage unit of program codes for maintaining or carrying over as realizing method in the embodiment of the present disclosure.

### DETAILED DESCRIPTION

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, Other embodiments obtained by common technicians of the field under the condition that no creative work is made all belong to the protection scope of the present disclosure.

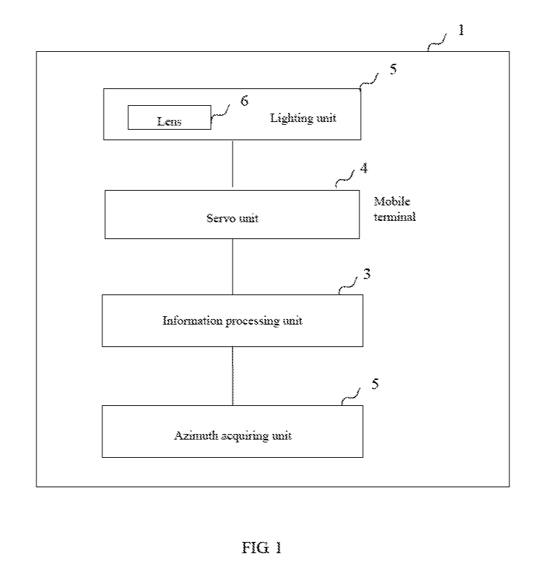

FIG. 1 shows the structure block diagram of the mobile terminal with a flashlight in the embodiment of the present disclosure.

The illuminable mobile terminal 1 of the embodiment includes an azimuth acquiring unit 2, an information processing unit 3, a servo unit 4 and a lighting unit 5, where the azimuth acquiring unit 2 is used for acquiring azimuth information data of a user in real time; the information processing unit 3 is used for extracting direction information data in the azimuth information data acquired by the azimuth acquiring unit 2 and transmitting the direction information data to the servo unit 4; the servo unit 4 is used for adjusting the angle of the lighting unit 5 according to the direction information data; the lighting unit 5 is used for projecting a light pillar to the ground or the surface of a building.

In the embodiment, the mobile terminal 1 may be a portable mobile terminal such as a mobile phone or a tablet personal computer; the azimuth acquiring unit 2 may be an electronic compass or a 3D electronic, compass, and the 3D electronic compass may acquire azimuth information data of the user more precisely; the information processing unit 3 may be a CPU; the servo unit 4 may be a driving motor; the lighting unit 5 may include a lens 6 with a marking arrow on the surface.

The azimuth information data of the user may be acquired by the electronic compass or the 3D electronic compass in the mobile phone or the tablet personal computer in real time, the direction information data in the azimuth information data of the user may be extracted by the CPU and transmitted to the driving motor, the driving motor is used for adjusting the angle of the lens with the marking arrow on the surface according to the acquired direction information data, the light beam may be projected to the ground or the surface of the building through the lens with the marking arrow, the user may determine the direction according to the arrow indicating direction on the ground or the surface of the building, then the effect that both light and direction information are provided to the user at the same time under the conditions that the view is poor or the light is dim and the GPS is “lost” may be achieved.

The embodiments of the mobile device described above are only schematic, a unit which may be described as a separated part may be or not physically separated, a member for unit display may be or not a physical unit, that is the member may be located at one place or distributed to multiple network units. A part of or all modules may be selected to achieve the purposes of the schemes of the embodiments according to practical demands. The present disclosure may be understood and implemented by common technicians of the field without creative work.

According to the description above, technicians of the field may clearly understand that the description may be achieved through software together with an essential hardware platform, and of course through hardware as well. Based on the understanding, the technical scheme or the contribution to the prior art may be fundamentally reflected in a software product mode, and a computer software product may be stored in a computer readable storage medium such as an ROM/RAM, a disc and a compact disc, and includes a plurality of instructions for enabling computer equipment (such as a personal computer, a server or network equipment) to execute embodiments or methods described in parts of the embodiments.

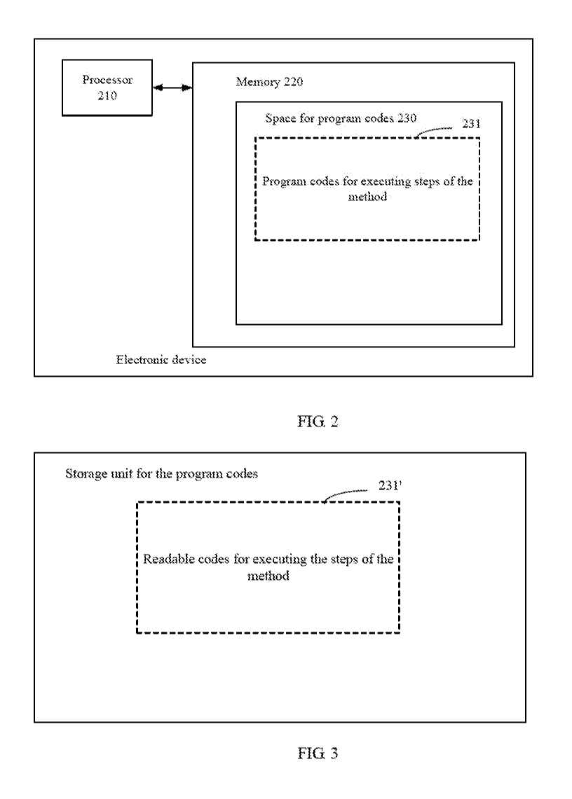

FIG. 2 shows a computing device for realizing an adjusting method according to vehicle information of the present disclosure. The computing device (such as the mobile terminal) traditionally includes a processor 210 and a program product or a readable medium in the mode of a memory 220. The memory 220 may be an electronic memory such as a flash memory, an EEPROM (electronic erasable programmable read-only memory), an EPROM or an ROM. The memory 220 includes a storage space 230 for program codes 231 for executing steps of any one of methods used in the data transmission process. For example, the storage space 230 for the program codes may include various program codes 231 for realizing different steps of the methods used in the data transmission process respectively. The program codes may be read from one or more program products or written into one or more program products. The program product includes a program code earlier such as a storage card. Such program product is generally a portable or fixed storage unit as shown in FIG. 3. The storage unit may include a storage section, a storage space and the like which is arranged like the memory 220 in the computing device as shown in FIG. 2. The program codes may be compressed in an appropriate mode. Generally, the storage unit includes readable codes 231′, that is, codes which may be read by a processor such as the processor 210, and when being operated by the processor of the computing device, the codes may enable the processor of the computing device to execute different steps of the method used in the data transmission process described above.

The final description is that the previous embodiments are not used for limiting the technical scheme of the present disclosure, but only for describing. Although detailed description of the present disclosure is given with reference to the previous embodiments, the common technicians of the field should understand that the technical scheme recorded by each of the previous embodiments may be modified, or one part of technical characteristics may be equivalently replaced; however, the modification or replacement does not enable the essence of the corresponding technical scheme to get out of the spirit and scope of the technical scheme in each embodiment of the present disclosure.

What is claimed is:

1. An illuminable mobile terminal, comprising an azimuth acquiring unit, an information processing unit, a servo unit and a lighting unit, wherein
the azimuth acquiring unit is used for acquiring azimuth information data of a user in real time;
the information processing unit is used for extracting direction information data in the azimuth information data acquired by the azimuth acquiring unit and transmitting the direction information data to the servo unit;
the servo unit is used for adjusting the angle of the lighting unit according to the direction information data; and
the lighting unit is used for projecting a light pillar to the ground or the surface of a building.

2. The mobile terminal according to claim 1, wherein the azimuth acquiring unit is an electronic compass or a 3D electronic compass.

3. The mobile terminal according to claim 1, wherein the information processing unit is a CPU.

4. The mobile terminal according to claim 1, wherein the servo unit is a driving motor.

5. The mobile terminal according to claim 1, wherein the lighting unit further comprises a lens with a marking arrow and is used for projecting a light beam to the ground or the surface of the building through the lens with the marking arrow.

6. The mobile terminal according to claim 1, wherein the mobile terminal is a mobile phone or a tablet personal computer.
